(19) United States
(12) Patent Application Publication
(10) Pub. No.: US 2010/0200176 A1
(43) Pub. Date: Aug. 12, 2010

(54) ACTIONNEUR TUBULAIRE POUR L'ENTRAINEMENT D'UN ECRAN DOMOTIQUE

(76) Inventor: Denis Magli, Taninges (FR)

Correspondence Address: FROMMER LAWRENCE & HAUG, 745 FIFTH AVENUE- 10TH FL., NEW YORK, NY, 10151, US

(21) Appl. No.: 12/671,438

(22) PCT Filed: Jul. 31, 2008
(86) PCT No.: PCT/IB2008/053071

§ 371 Date: Jan. 29, 2010

(30) Foreign Application Priority Data
Aug. 1, 2007 (FR) 07 05633

(51) Int. Cl. E06B 9/56

(52) U.S. Cl. 160/300; 160/291

(57) ABSTRACT

The invention relates to a tubular actuator (1) for a home automation screen, that comprises: a stationary point (20: 220: 420) at least partially imbedded in the tube through one end thereof; and stop means (21, 11; 221, 211; 321; 421, 411) of the stationary point at least in translation relative to the tube, characterised in that the tubular actuator includes locking means (32; 232; 432) for the stop means.

The invention relates to a tubular actuator of a movable screen used in a home-automation installation, such as a roller blind or an awning. The invention also relates to the home-automation installation comprising such an actuator.

A tubular actuator usually comprises a tube into which are inserted a gear motor on one side and a fixed point at the other end. The fixed point forms a kind of plug at the end of the tube and preferably incorporates a portion of the connection system of the motor and may comprise electronic or mechanical means for controlling the power supply of the motor. This fixed point has a mainly mechanical function: it is secured to the tube and participates actively in absorbing the torque of the actuator relative to the frame to which it is attached. The fixed point must therefore be secured to the tube. To immobilize the fixed point axially, it is normal to assemble radially a screw to this part, once mounted in the tube, so that the head of the screw becomes housed in a hole of the tube. It is the interaction between the head of the screw and the hole that prevents the axial translation. In order to remove the fixed point, it is necessary to remove the screw with a tool. For some actuators, the screw has been replaced by a clip placed on the fixed point and its end is housed in the hole of the tube. In order to remove the fixed point, it is necessary in this case to press on the end of the clip to disengage it. The clip is dimensioned for a good retention of the fixed point and is rigid, therefore requiring the use of a tool for the removal. This rigidity also limits the inopportune operations. Concerning the absorption of torque, whether it be a screw or a clip, this element does not participate very much in this transmission of force. The torque is usually absorbed by lugs placed on the fixed point interacting with notches in the tube. In many cases, the fixed point also comprises specific shapes interacting with matching shapes of a support attached to the frame. This combination allows good absorption of the torque between the frame and the tube of the actuator. The interface may also be achieved by an intermediate part to which the fixed point is attached.

Known, for example, from document FR 2 840 012 is a fixed point mounted in an actuator tube and held in axial translation by a retractable pin on the fixed point interacting with a hole on the tube.

All these devices have the disadvantage of being relatively difficult to remove because they require a tool for their removal.

The object of the invention is to provide a tubular actuator alleviating the above disadvantages and improving the known tubular actuators of the prior art. In particular, the invention proposes a tubular actuator having a simple structure and of which the fixed point can be removed simply without the aid of a tool, the fixed point nevertheless not being removed inadvertently. The invention also proposes an installation comprising such an actuator.

The actuator according to the invention is defined by claim 1.

Various embodiments of the actuator are defined by dependent claims 2 to 10.

The home-automation installation according to the invention is defined by claim 11.

The invention will be better understood on reading the following description, given only as an example and made with reference to the appended drawings in which:

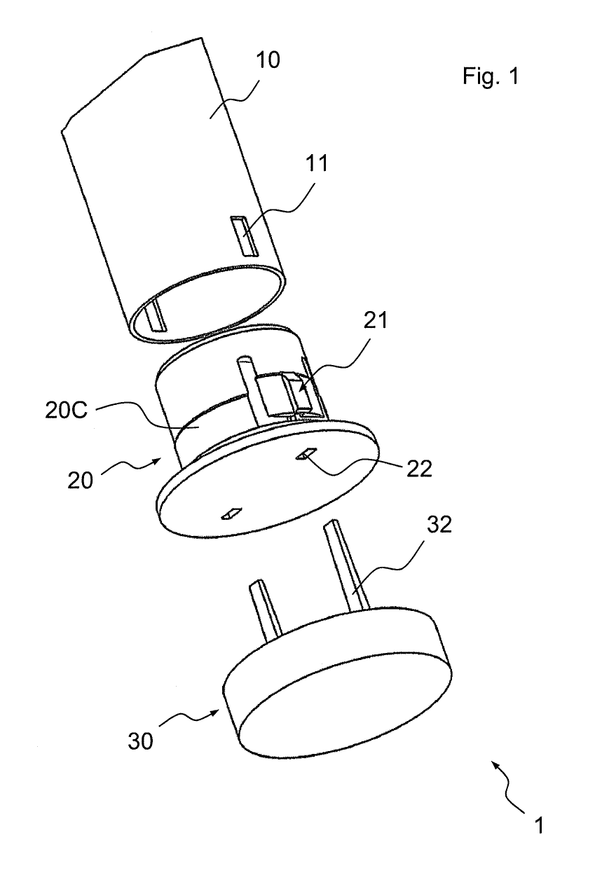

FIG. 1 is a view in perspective of some elements forming a tubular actuator according to a first embodiment according to the invention;

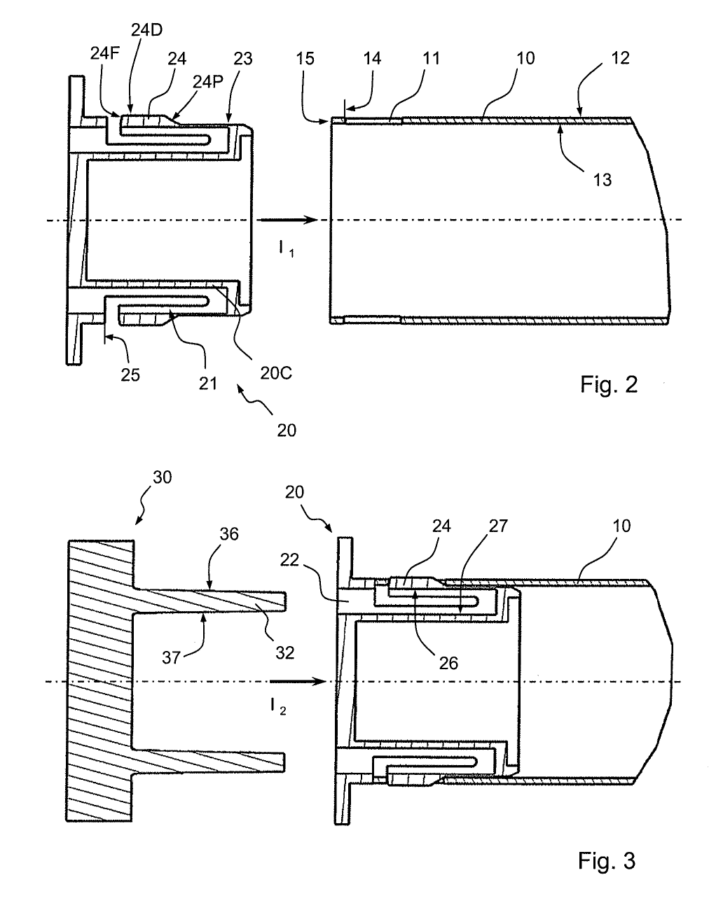

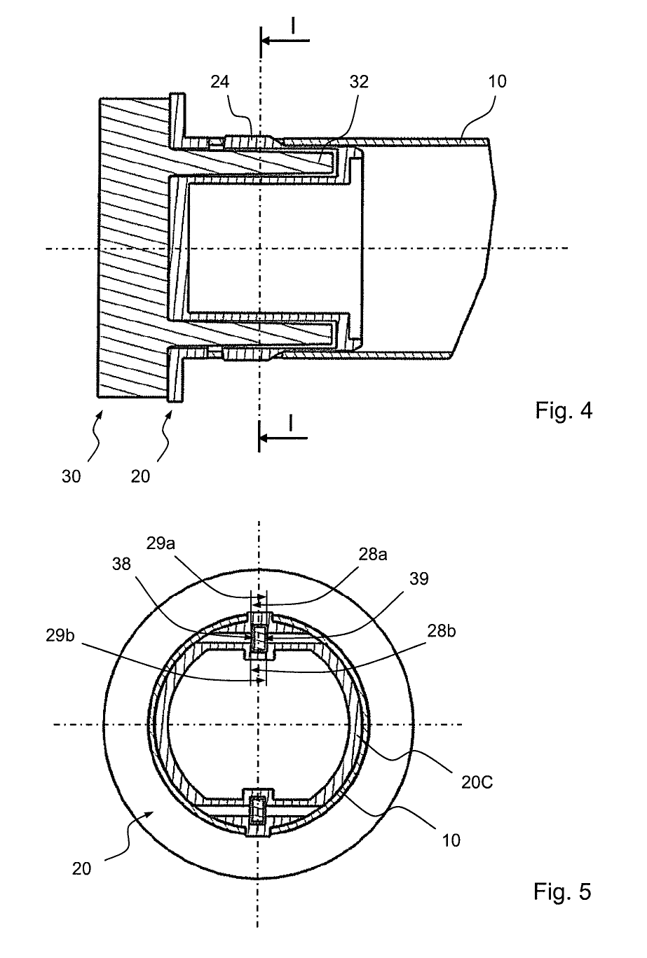

FIGS. 2 to 5 are views in section representing the various steps for assembling the first embodiment of an actuator according to the invention;

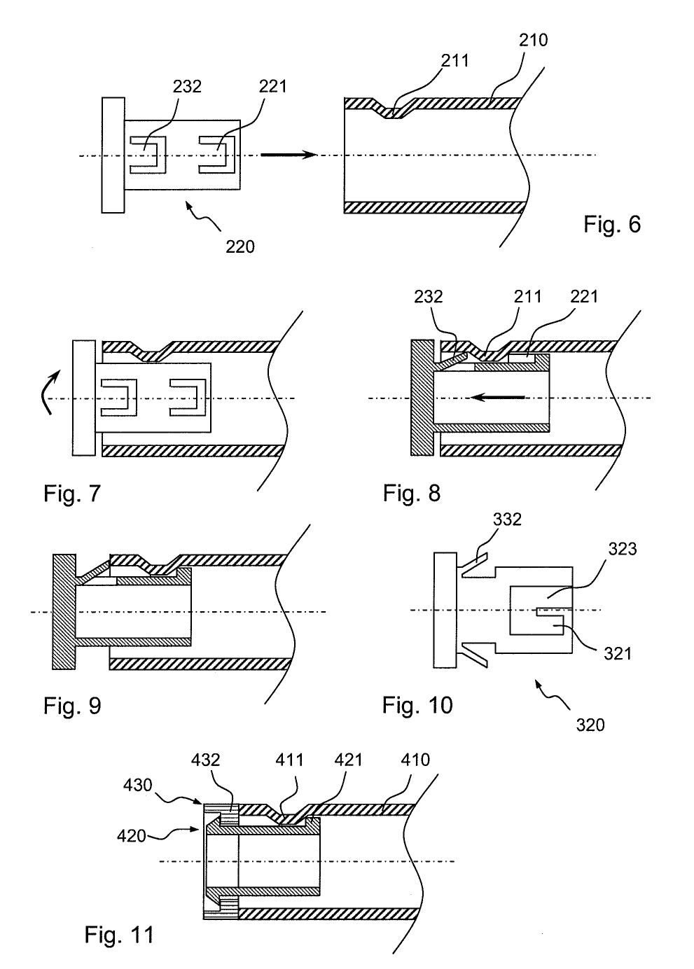

FIGS. 6 to 9 are views in partial section representing the various steps for assembling a second embodiment of an actuator according to the invention;

FIG. 10 is a view representing a third embodiment of an actuator according to the invention;

FIG. 11 is a view in section representing a fourth embodiment of an actuator according to the invention.

The actuator according to the invention has stopping or indexing means interacting to stop a fixed point, such as a socket, for example attached or designed to be attached to the structure of a building, at least axially relative to a tube, that is to say to immobilize the relative movements of the fixed point and the tube in at least the axial direction. These stopping or indexing means may be dimensioned in order to ensure a weak stopping strength at least axially, only in order to preassemble the fixed point and the tube. The fixed point can therefore be inserted into the tube with a light force. When they perform their function of indexing or retaining the fixed point in the tube, the stopping means are called active or in a position of interaction. Beyond an axial force exerted on the fixed point, the latter is disengaged from the tube, by elastic deformation of at least one of the stopping means. According to another embodiment, axial stopping is obtained by virtue of the positioning of a stopping means opposite a second matching stopping means. In this case, in order to disengage the fixed point from the tube, it is necessary to move one of the stopping means relative to the other so that it is no longer opposite the matching stopping means so that it no longer interacts with this matching stopping means. The stopping means then become inactive, that is to say that they leave their position of interaction. Another means of making them inactive consists in acting directly on one of them, for example, by unclipping a stopping means which would be a clip. This configuration makes it easier to remove and assemble the actuator in the event of after-sales service and to do so without the aid of tools. To secure the assembly and ensure that the parts remain secured in translation in use, the invention proposes locking means mounted, for example, on the fixed point making the stopping means still active, that is to say by keeping the stopping means in their position of interaction. The locking means can, for example, prevent the elastic deformation or the movement of the stopping means. Therefore, because it is necessary either to deform or to move the stopping means in order to separate the fixed point from the tube, the locking means make it possible to maintain the assembly of the two parts. In other words, these locking means prevent the stopping means from being deactivated. Therefore, as long as the locking means are in place, it is not possible to separate the fixed point from the tube without damaging the stopping means. The locking means are called active when they perform their function of preventing the deformation or movement of the stopping means and are called inactive when they do not perform their function of preventing deformation or movement of the stopping means.

Advantageously, the locking means makes it possible to strengthen the stopping means and more particularly their rigidity to the torque that may be transmitted from the tube to the fixed point. By adapting appropriate absorption surfaces between the locking means, the body of the fixed point and the stopping means, a portion of the transmitted torque may be absorbed at the stopping means. The latter therefore participate better in the transmission of the torque.

This actuator also makes it possible to add functions to the locking means, which makes the solution more appropriate for mass production and more economical. It is possible, for example, for the power outlet of the motor to provide the locking. A second alternative consists in it being placed on a part furnished with interface surfaces with the support attached to the frame. This part then forms a head that can be customized. Since a portion of the actuator formed of the tube, the reduction gear and the fixed point is standard, it is sufficient then to adapt the head to suit the installation.

FIG. 1 represents a first embodiment of a tubular actuator 1 designed to drive a tube for winding a screen of the awning or roller blind type. This actuator comprises a tube 10 inside which a reduction gear (not shown) is inserted protruding on one side. At the other end, the tube is closed off by a fixed point 20 to which a head 30 is attached.

The composition and assembly of these three elements are described with reference to FIGS. 2 to 4.

According to this embodiment, the stopping means comprise a first means on the fixed point and a second means on the tube. The stopping means make it possible to stop the fixed point in the tube at least in translation along the axis of the tube. The first means comprises two elastic claws 21 provided on the body 20C of the fixed point and clipping into the second means comprising two holes 11 provided on the tube. As a variant, the fixed point can have only one elastic claw or more than two elastic claws. The elastic claws 21 extend axially over the external diameter 23 of the portion of the fixed point penetrating the tube. This external diameter is slightly smaller than the internal diameter 13 of the tube. The elastic claws each terminate in a protrusion 24 extending radially to a diameter 24D greater than the internal diameter 13 of the tube and, preferably, smaller than the external diameter 12 of the tube. The protrusion also comprises a slope 24P designed to make it easier for the elastic claw to flex. Specifically, the insertion I₁ of the fixed point into the tube has the effect of causing the elastic claw to flex radially when the tube comes into contact with the slope 24P. The protrusion then retracts, the diameter 24D of the protrusion becoming smaller than the internal diameter of the tube. When the protrusion is positioned facing an aperture 11, the claw resumes its rest position through its elasticity. The protrusion then becomes housed in the hole. Thus assembled, the fixed point is immobilized axially relative to the tube, in one direction, by the contact of a face 24F of the protrusion against a face 14 of the hole and, in the other direction, by the contact of a face 15 of the end of the tube against a face 25 of the fixed point. If the fixed point is fully inserted into the tube, stopping can be obtained only by the contacts between the faces of the protrusion and the faces of the hole 11. Similarly, the fixed point is prevented from rotating about the axis of the tube by contact of faces of the protrusion with faces of the hole.

To disassemble the fixed point, it is sufficient to disengage the elastic claw by applying a radial force to the protrusion which can be accessed through the hole of the tube. This action flexes the elastic claw allowing the protrusion to retract. The elastic claw may be dimensioned so that this radial force is not considerable but its axial strength to axially stop the fixed point is sufficient for the fixed point to remain secured to the tube when it is pushed lightly in this direction. Such dimensioning also induces a slight mechanical resistance in order to stop the fixed point rotating in the tube.

To increase and to secure the axial mechanical resistance and prevent handling errors, a locking means is put in place in the fixed point. This locking means makes it possible to prevent the flexing deformation of the elastic claws. In the present illustration, it involves a head 30 furnished with bars inserted into housings 22 provided in the fixed point. These housings are arranged so that, when the bars 32 are inserted therein, the flexing deformations of the elastic claws are prevented. For example, the housings have rectangular sections and are placed straddling the elastic claws 21 and the body 20C of the fixed point. The insertion I₂ of the head into the fixed point locks the elastic claws. To do this, with reference to FIG. 3, the bottom face 26 of the protrusion comes into contact with the top face 36 of the locking bar 32. The bottom face 37 then presses on the rigid face 27 of the body of the fixed point. The protrusion is prevented from moving axially. The protrusion therefore always remains housed in the hole of the tube. Therefore, the function of the locking means is to ensure that the means for stopping the fixed point relative to the tube remain active, that is to say to ensure that the fixed point remains secured to the tube (at least in translation if the stopping means are means for stopping in translation) including under the effect of axial forces or radial forces on the protrusions of the elastic claws.

In order that the head remains assembled to the fixed point, fastening means (not shown) must be provided between these two parts. These two parts are put under slight strain in use. The dimensioning of these means is not restricting; it may be, for example, an assembly by clipping.

Advantageously, the locking bar is also prevented from rotating about the axis of the tube, both on the side of the elastic claw and on the side of the body of the fixed point. This has the effect of reinforcing the mechanical resistance of the elastic claw in preventing rotation. Consequently, a torque applied to the tube can be mainly or exclusively transmitted to the body of the fixed point via the elastic claws. The force is transmitted to the protrusion via the hole of the tube. It is then transmitted to the locking bar via the contact between the faces 28a or 29a of the elastic claw and 38 or 39 of the bar. The torque is then transmitted to the body of the fixed point via the contact between the faces 39 or 38 of the bar and 29b or 28b of the body of the fixed point. It is then transmitted to the head, for example as an obstacle by virtue of the appropriate shapes (not shown). The more elastic claws there are, the better the force is distributed. The dimensioning of the elastic claws can therefore be optimized. If the dimensioning does not make it possible to transmit the desired torque, notches may be arranged on the tube so as to interact with matching lugs on the fixed point. And finally, the force is transmitted to a support fixed to the frame via interface surfaces (not shown) of the head. Therefore, in order to adapt to the various supports on the market, only the head has to change, the other elements of the actuator being standard.

In the variant described above, the locking means are incorporated into a head fitted onto the fixed point. According to another variant, the locking of the clips is activated following the fitting of the power cable outlet into the fixed point. In yet another variant, the locking means may also have no function other than the locking of the elastic claws.

Elastic claws as described make it possible to provide good stopping strength in axial translation and require a slight force in a perpendicular direction in order to separate the assembly.

In the embodiment described, the elastic claws are placed on the fixed point but they may form part of the tube. Moreover, it is not necessary to have holes on the tube; bosses on the tube can allow the axial stopping. The hole may be used only for disengaging the elastic claws and not for the axial hold. In the embodiment described, the stopping means comprise elastic claws extending longitudinally; however, they could be in particular retractable lugs or any other clipping means.

In a second embodiment, described below with reference to FIGS. 6 to 9, the function for stopping the translation of the fixed point 220 in the tube 210 is provided by stopping means comprising a deformation 211 of the tube 210, an indentation for example. This variant provides a better seal of the actuator because it removes a possibility of water entry relative to a solution with an aperture. The stopping means also comprise, on the fixed point 220, a U-shaped protrusion 221. This protrusion is placed on the external diameter of the body of the fixed point penetrating the tube. This external diameter is dimensioned so that the fixed point can be inserted into the tube after it is deformed. The protrusion extends radially to a diameter slightly smaller than the internal diameter of the tube. The fixed point also comprises locking means. These locking means comprise an elastic claw 232, also placed on the external diameter of the body of the fixed point and, extending to a greater diameter than the internal diameter of the tube and slightly smaller than the external diameter of the tube. These locking means also comprise an end of the tube designed to interact by contact with the elastic claw. The assembly of these parts requires specific operations. The fixed point is oriented relative to the indentation of the tube, that is to say by arranging an angular offset of the protrusion so that it does not abut against the deformation of the tube when the fixed point is inserted. For the protrusion to move past the deformation of the tube, the elastic claw must be deformed by flexing, thus making it possible to insert the fixed point more deeply into the tube. Once inserted into the tube, the fixed point is turned so as to align the deformation of the tube with the U of the protrusion. It is then sufficient to pull the fixed point so that the deformation of the tube is positioned inside the U and the elastic claw resumes its rest position through its elasticity. This solution therefore allows a good mechanical resistance of axial stopping of the fixed point in the tube and a good absorption of torque. It is preferable to have at least two deformations interacting with two U-shaped protrusions and two elastic claws.

With respect to the stopping means provided on the fixed point, the latter may be a recess rather than a protrusion as illustrated in FIG. 10. The body of the fixed point may have an external diameter close to the internal diameter of the tube, thus ensuring a better guidance into the tube when it is inserted. The body is furnished with grooves 323 forming a pathway making it possible to guide the deformation of the tube to an immobilization zone 321 corresponding to the U in the embodiment described above. The locking means 332 are similar to those of the preceding solution.

Many variants of this embodiment can be envisaged again using the bayonet principle. The alternatives may relate to other locking means, instead of the elastic claw. It is therefore possible to attach a head to the fixed point, the latter having to hold the U of the protrusion around the deformation of the tube. Such a solution is illustrated in FIG. 11 in which a head 430 is fitted to a fixed point 420. This head has shape 432 making it possible to position the fixed point relative to the tube 410. The assembly of the fixed point and the head can be carried out in many ways, clipping, bayonet, etc.

In other words, the tubular actuator according to the invention comprises:
a tube 10 furnished with a first stopping means 11, 211, 411,
a fixed point 20, 220, 420 furnished with a second stopping means 21, 221, 321, 421,
   said fixed point being at least partially inserted into the tube through one of its ends and being able to be positioned relative to the tube so that the first and second stopping means interact in order to immobilize the axial movement of the fixed point relative to the tube. The tubular actuator comprises locking means 32, 232, 432 which, when they are activated, make it possible to hold the first and second stopping means in a position of interaction.

Other solutions combining the various embodiments described can be envisaged.

1. A tubular actuator of a home-automation screen comprising:
a tube,
a fixed point at least partially inserted into the tube through one of its ends, and
stopping means for stopping the fixed point movement relative to the tube, at least in translation,
wherein the tubular actuator comprises locking means (32; 232; 432) for locking the stopping means.

2. The tubular actuator as claimed in claim 1, wherein the stopping means comprise a first means on the fixed point and a second means on the tube, the first and the second means interacting as an obstacle.

3. The tubular actuator as claimed in claim 2, wherein the first means is an elastic means.

4. The tubular actuator as claimed in claim 2, wherein the second means is a hole.

5. The tubular actuator as claimed in claim 1, wherein the stopping means make it possible to stop the fixed point from rotating in the tube.

6. The tubular actuator as claimed in claim 2, wherein the locking means secure in rotation the first means and the body of the fixed point or enhance the torque that can be transmitted from the first means to the body of the fixed point.

7. The tubular actuator as claimed in claim 1, wherein the locking means comprises a part designed to be housed in a fixed support on a building.

8. The tubular actuator as claimed in claim 1, wherein the locking means comprises a part being engaged at least partially in translation in the fixed point.

9. The tubular actuator as claimed in claim 1, wherein the locking means comprises an electric power outlet of the actuator.

10. The tubular actuator as claimed in claim 1, wherein the locking means comprises an elastic tab coming to rest against one end of the tube.

11. A home-automation installation characterized in that it comprises a tubular actuator as claimed in claim 1.
